(19) United States
(12) Patent Application Publication
(10) Pub. No.: US 2014/0190804 A1
(43) Pub. Date: Jul. 10, 2014

(54) LUMINOUS PRESS KEY MODULE

(71) Applicant: CHANGSHU SUNREX TECHNOLOGY CO., LTD., Changshu (CN)

(72) Inventor: Qing ZHANG, Changshu (CN)

(73) Assignee: CHANGSHU SUNREX TECHNOLOGY CO., LTD., Changshu (CN)

(21) Appl. No.: 13/737,288

(22) Filed: Jan. 9, 2013

(51) Int. Cl. H01H 13/10

(52) U.S. Cl. CPC H01H 13/10
USPC 200/314

(57) ABSTRACT

A luminous press key module includes: a key cap; a base plate disposed under the key cap and formed with a base plate opening; a circuit unit disposed between the base plate and the key cap; a restoring unit disposed between the key cap and an upper surface of the circuit unit and abutting against the key cap; and a luminous unit including a luminous element disposed on a lower surface of the circuit unit opposite to the upper surface of the circuit unit.

### BACKGROUND OF THE INVENTION

1. Field of the Invention

This invention relates to a press key module, more particularly to a luminous press key module.

2. Description of the Related Art

A conventional luminous press key module which facilitates operation thereof in a dark environment comprises: a key cap, a scissors linkage, a restoring unit, a membrane circuit board, and a luminous unit. The key cap together with the scissors linkage can be moved to compress the restoring unit so as to make contact between the restoring unit and the membrane circuit board for generating an electrical signal. The luminous unit includes a light emitting diode disposed on an upper surface of the membrane circuit board and facing the key cap, and a light guiding mask that is disposed on the top surface of the membrane circuit board, and that is recessed to be formed with a space for accommodating the light emitting diode.

However, the downward movement of the key cap, the scissors linkage, and the restoring unit might be obstructed by the light guiding mask, which may lead to unsuccessful generation of the electrical signal. Moreover, the press key module is incapable of being pressed smoothly since the key cap may abut against the light guiding mask when the key cap is pressed.

### SUMMARY OF THE INVENTION

Therefore, an object of the present invention is to provide a luminous press key module that can overcome the aforesaid drawbacks associated with the prior art.

Accordingly, a luminous press key module of this invention comprises:

a key cap;

a base plate disposed under the key cap and formed with a base plate opening;

a circuit unit disposed between the base plate and the key cap, and having at least a light-transmission region that corresponds to the base plate opening and that is made of a light-permeable material;

a restoring unit disposed between the key cap and an upper surface of the circuit unit and abutting against the key cap so as to provide a restoring force for biasing the key cap away from the circuit unit; and

a luminous unit including a luminous element that is electrically connected to the circuit unit, that is disposed on a lower surface of the circuit unit opposite to the upper surface of the circuit unit, and that is accommodated in the base plate opening, the luminous element emitting light to the light transmission region for illuminating the key cap.

### BRIEF DESCRIPTION OF THE DRAWINGS

Other features and advantages of the present invention will become apparent in the following detailed description of the preferred embodiments of the invention, with reference to the accompanying drawings, in which:

FIG. 1 is an assembled perspective view of the first preferred embodiment of a luminous press key module according to this invention;

FIG. 2 is an exploded perspective view of the first preferred embodiment;

FIG. 3 is a top schematic view of the first preferred embodiment;

FIG. 4 is a sectional view taken along line IV-IV in FIG. 3, illustrating a progressing path of a light beam from a luminous element to a key cap;

FIG. 5 is a sectional view illustrating an electrical contact between a contact portion and a circuit unit when the key cap is pressed;

FIG. 6 is an assembled perspective view of the second preferred embodiment of the luminous press key module according to this invention;

FIG. 7 is an exploded perspective view of the second preferred embodiment;

FIG. 8 is a top schematic view of the second preferred embodiment;

FIG. 9 is a sectional view taken along line IX-IX in FIG. 8, illustrating a progressing path of a light beam from a luminous element to a key cap; and

FIG. 10 is a sectional view illustrating an electrical contact between a contact portion and a circuit unit when the key cap is pressed.

### DETAILED DESCRIPTION OF THE PREFERRED EMBODIMENTS

Before the present invention is described in greater detail with reference to the accompanying preferred embodiments, it should be noted herein that like elements are denoted by the same reference numerals throughout the disclosure.

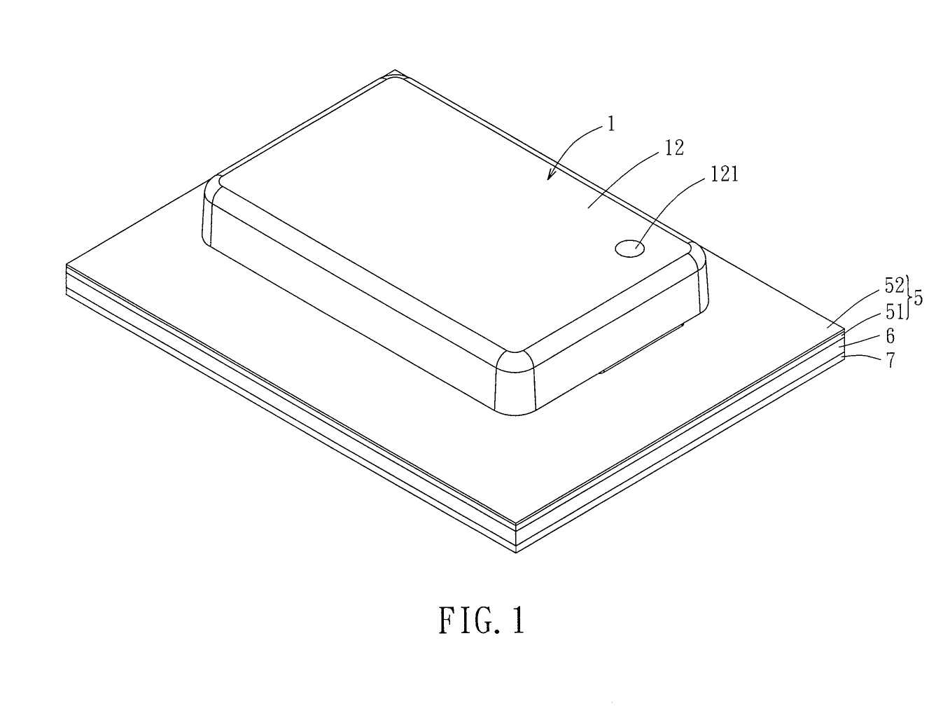

FIGS. 1 to 3 are respectively an assembled perspective view, an exploded perspective view, and a top schematic view of the first preferred embodiment of a luminous press key module according to this invention. The luminous press key module comprises: a key cap 1, a scissors linkage 2, a restoring unit 3, a circuit unit 5, a base plate 6, a bottom cover 7, and a luminous unit 8.

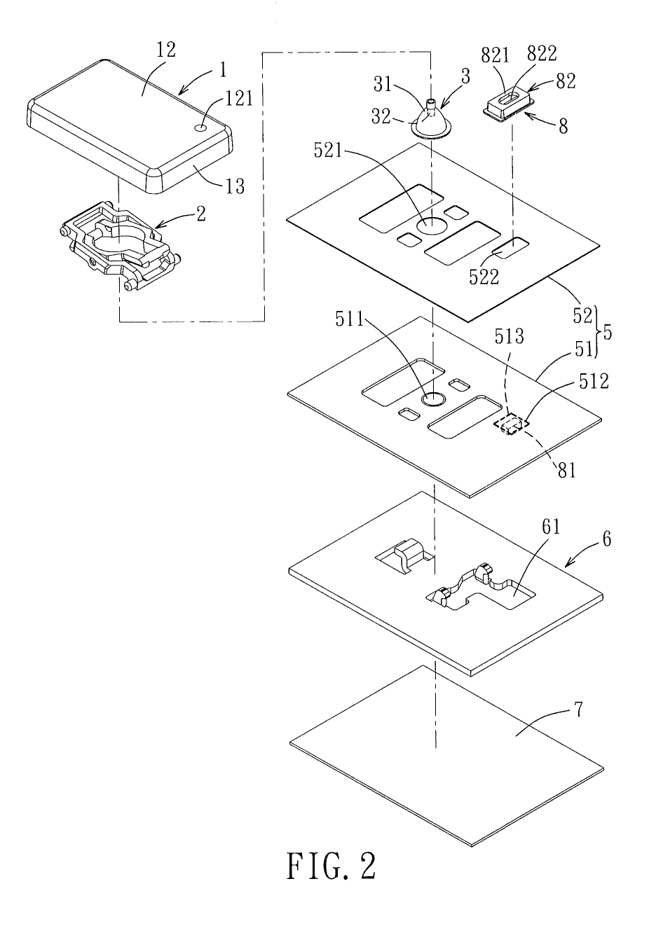

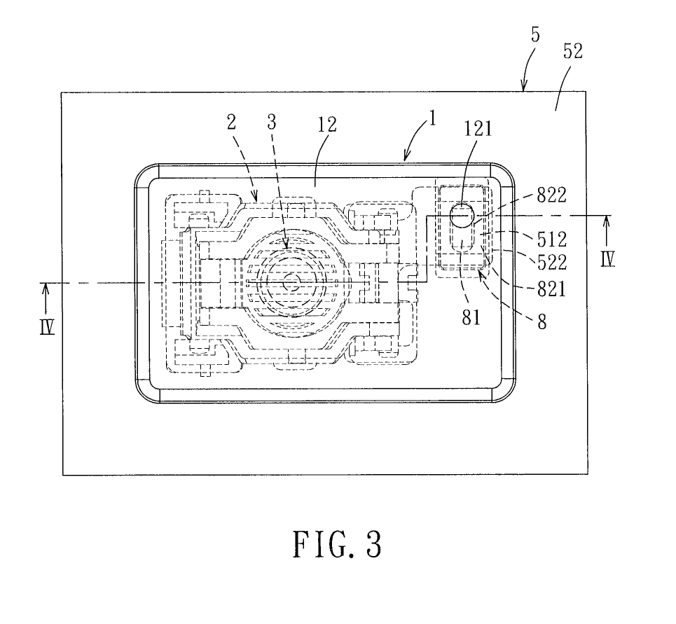

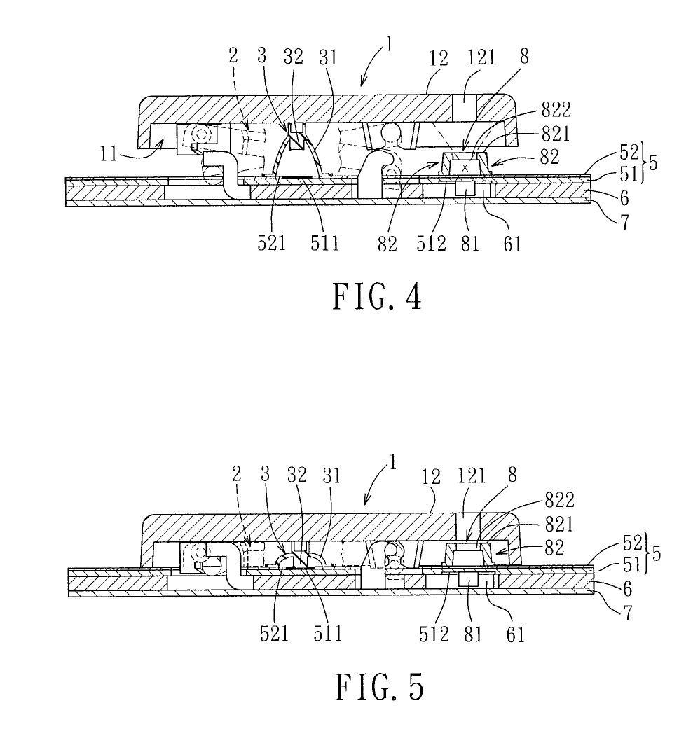

FIG. 4 is a sectional view taken along line IV-IV in FIG. 3, in which the key cap 1 is at a normal position. FIG. 5 is a sectional view showing the key cap 1 at a pressed position. As shown in FIGS. 2, 4, and 5, the key cap 1 has a bottom side that is recessed to form a recess 11, and includes a key cap plate 12 and a peripheral flange 13 extending downwardly from an outer periphery of the key cap plate 12. The key cap plate 12 and the peripheral flange 13 cooperatively define the recess 11. The scissors linkage 2 is connected to and elevatably disposed between the key cap 1 and the base plate 6. The restoring unit 3 is disposed between the key cap 1 and an upper surface of the circuit unit 5 and abuts against the key cap 1 so as to provide a restoring force for biasing the key cap 1 away from the circuit unit 5. The restoring unit 3 includes a dome-like portion 31 and a contact portion 32 protruding from an inner surface of the dome-like portion 31 toward the circuit unit 5 and capable of contacting the circuit unit 5 to generate an electrical signal.

The circuit unit 5 is disposed between the base plate 6 and the key cap 1, and includes a membrane circuit board 51 and an insulator layer 52 disposed on an upper surface of the membrane circuit board 51. The insulator layer 52 is formed with a through hole 521 to allow the contact portion 32 of the restoring unit 3 to pass through the insulator layer 52. The membrane circuit board 51 has an upper surface which is formed with a conductive portion 511. The conductive portion 511 is aligned with the through hole 521 to allow the contact portion 32 of the restoring unit 3 to establish electrical contact with the conductive portion 511. The conductive portion 511 can be, e.g., a membrane switch or a trigger switch. The base plate 6 is disposed under the key cap 1. The bottom cover 7 is disposed under the base plate 6.

When pressed, the key cap 1 is moved downwardly together with the scissors linkage 2 toward the base plate 6 so as to compress the restoring unit 3. The contact portion 32 of the restoring unit 3 electrically contacts the conductive portion 511 of the membrane circuit board 51, thus generating an electrical signal. In this embodiment, the insulator layer 52 is made of Mylar.

The luminous unit 8 includes a luminous element 81 and a light guiding mask 82. The luminous element 81 is disposed on a lower surface of the membrane circuit board 51 opposite to the upper surface of the membrane circuit board 51 and is electrically connected to the membrane circuit board 51. The light guiding mask 82 is disposed on an upper surface of the insulator layer 52. In consideration of accommodating the luminous unit 8 and the progressing path of light from the luminous element 81, the insulator layer 52 of the circuit unit 5 is formed with a through hole 522, and the membrane circuit board 51 has a light transmission region 512 that corresponds in position to the through hole 522 and that is made of a light-permeable material. The lower surface of the membrane circuit board 51 in the light transmission region 512 is formed with a blind hole 513 corresponding in position to the light guiding mask 82 for receiving the luminous element 81. The base plate 6 is formed with a base plate opening 61 that is in spatial communication with the blind hole 513 in the lower surface of the membrane circuit board 51 to allow the luminous element 81 to extend into the base plate 6. The light guiding mask 82 disposed on the upper surface of the insulator layer 52 covers the through hole 522 of the insulator layer 52 and is aligned with the light-transmission region 512, the base plate opening 61, and the luminous element 81. Therefore, in this embodiment, the luminous element 81 is aligned with the light guiding mask 82 in a top-bottom direction. The light guiding mask 82 has a height that is measured from the upper surface of the insulator layer 52 and that is shorter than a depth of the recess 11 of the key cap 1 so that the light guiding mask 82 can be received in the recess 11 when the key cap 1 is at the pressed position (see FIG. 5). In this embodiment, the luminous element 81 is a light emitting diode.

FIG. 4 shows a progressing path of a light beam from the luminous element 81. Since the light-transmission region 512 that corresponds in position to the base plate opening 61 of the base plate 6 and the luminous element 81 is made of the light-permeable material, the light beam emitted from the luminous element 81 can pass through the light-transmission region 512. The light guiding mask 82 has a top plate 821 formed with a light-permeable hole 822 which is capable of light concentrating and light permeation. The key cap plate 12 of the key cap 1 is formed with a perforation 121 which corresponds in position to the light-permeable hole 822 of the light guiding mask 82. In this embodiment, the perforation 121 of the key cap 1 is located at a symbol region (not shown). The light beam from the luminous element 81 passes through the light transmission region 512, the through hole 522 of the insulator layer 52, the light-permeable hole 822 of the light guiding mask 82 and the perforation 721 of the key cap 1, thereby illuminating the key cap 1.

Referring to FIGS. 4 and 5, in this embodiment, the luminous element 81 is disposed on the lower surface of the membrane circuit board 51, and the height of the light guiding mask 82 can be reduced so that the key cap 1 would not abut against the light guiding mask 82 when the key cap 1 is pressed and moves downwardly. Accordingly, downward movement of the restoring unit 3 associated with the scissors linkage 2 would not be obstructed and the electrical contact between the contact portion 32 of the restoring unit 3 and the conductive portion 511 of the membrane circuit board 51 can be ensured.

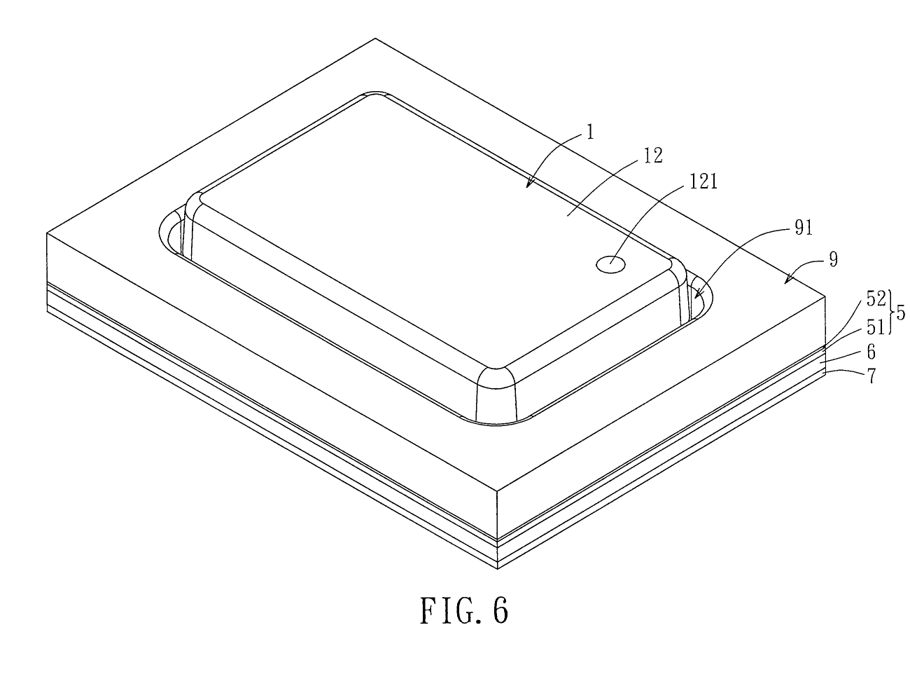

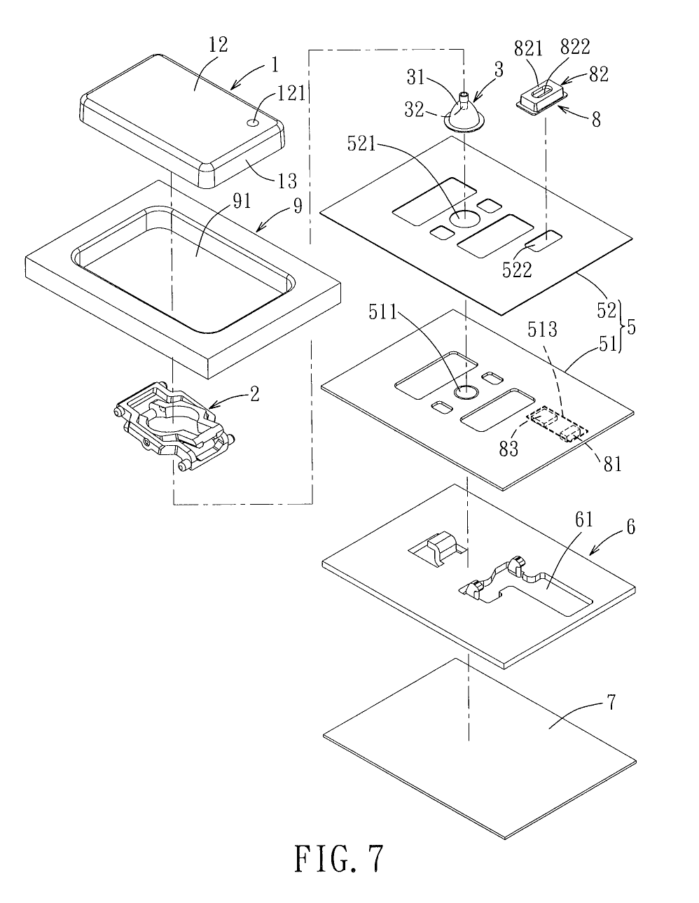

FIGS. 6 to 8 are respectively an assembled perspective view, an exploded perspective view, and a top schematic view of the second preferred embodiment of a luminous press key module according to this invention. The second preferred embodiment is similar to the first preferred embodiment except for the following differences. First, the luminous element 81 is accommodated in the blind hole 513 and is spaced apart from a light guiding plate 83, i.e., is not disposed immediately below the light guiding mask 82. The luminous press key module further comprises a frame 9 disposed on the insulator layer 52 of the circuit unit 5 and formed with a frame opening 91. The key cap 1 is movable in the frame opening 91. In this embodiment, at the normal position, the key cap plate 12 of the key cap 1 is exposed from the frame 9. The luminous unit 8 further includes the light guiding plate 83 that is accommodated in the blind hole 512 and the base plate opening 61, that is disposed on the lower surface of the membrane circuit board 51, and that is positioned immediately below the light guiding mask 82.

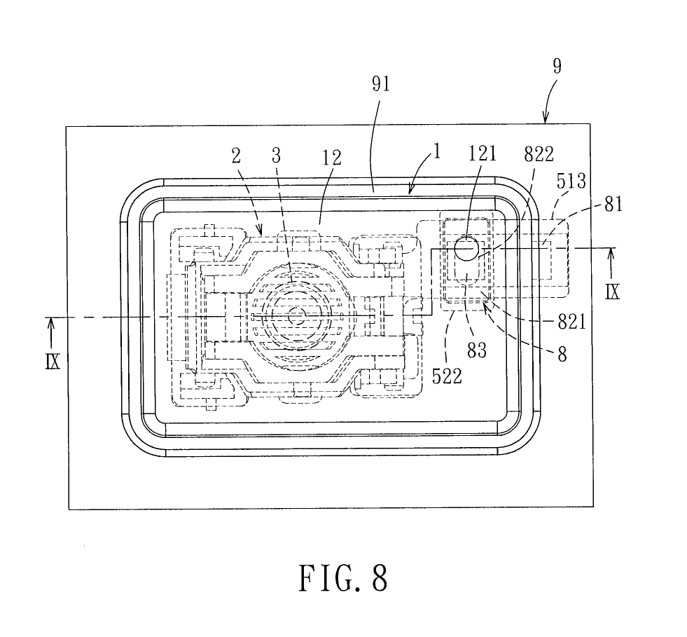

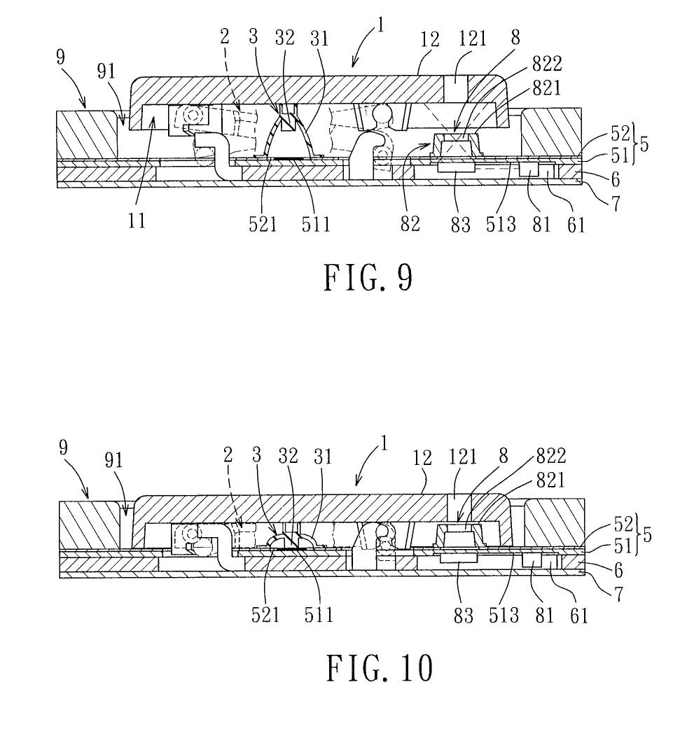

FIG. 9 is a sectional view taken along line IX-IX in FIG. 8 illustrating a progressing path of the light beam from the luminous element 81 to the key cap 1. FIG. 10 is a sectional view illustrating an electrical contact between the contact portion 32 and the circuit unit 5 when the key cap 1 in FIG. 9 is pressed. In this embodiment, the luminous element 81 emits the light beam to the light guiding plate 83 and the light beam is directed to the light guiding mask 82, followed by propagating to the perforation 121 of the key cap plate 12 via the light-permeable hole 822. To meet the design of the luminous unit 8, in this embodiment, the blind hole 513 in the membrane circuit board 51 and the base plate opening 61 in the base plate 6 have dimensions larger than those of the first preferred embodiment.

To sum up, the effect of the luminous press key module according to this invention resides in that the luminous element 81 is disposed on the lower surface of the membrane circuit board 51, and the height of the light guiding mask 82 can be reduced so that movement of the key cap 1, the restoring unit 3, and the scissors linkage 2 would not be obstructed, thereby resulting in good electrical contact between the restoring unit 3 and the membrane circuit board 51.

While the present invention has been described in connection with what are considered the most practical and preferred embodiments, it is understood that this invention is not limited to the disclosed embodiments but is intended to cover various arrangements included within the spirit and scope of the broadest interpretations and equivalent arrangements.

What is claimed is:

1. A luminous press key module, comprising:
a key cap;
a base plate disposed under said key cap and formed with a base plate opening;
a circuit unit disposed between said base plate and said key cap, and having at least a light-transmission region that corresponds to said base plate opening and that is made of a light-permeable material;
a restoring unit disposed between said key cap and an upper surface of said circuit unit and abutting against said key cap so as to provide a restoring force for biasing said key cap away from said circuit unit; and
a luminous unit including a luminous element that is electrically connected to said circuit unit, that is disposed on a lower surface of said circuit unit opposite to said upper surface of said circuit unit, and that is accommodated in said base plate opening, said luminous element emitting light to said light transmission region for illuminating said key cap.

2. The luminous press key module of claim 1, wherein said key cap has a bottom side that is recessed to forma recess, said luminous unit further including a light guiding mask that is disposed on said upper surface of said circuit unit corresponding to said base plate opening, that is disposed under said key cap, and that is extendable into said recess when said key cap is pressed, said light guiding mask having a height that is measured from said upper surface of said circuit unit and that is smaller than a depth of said recess of said key cap.

3. The luminous press key module of claim 2, wherein said light guiding mask has a top plate formed with a light-permeable hole.

4. The luminous press key module of claim 3, wherein said key cap includes a key cap plate and a peripheral flange extending downwardly from an outer periphery of said key cap plate, said key cap plate being formed with a perforation corresponding in position to said light-permeable hole of said light guiding mask.

5. The luminous press key module of claim 2, wherein said lower surface of said circuit unit has a blind hole corresponding to said light guiding mask, said blind hole being in spatial communication with said base plate opening and receiving said luminous element.

6. The luminous press key module of claim 4, further comprising a frame disposed on said circuit unit, said frame being formed with a frame opening, said key cap being capable of moving in said frame opening.

7. The luminous press key module of claim 6, wherein said lower surface of said circuit unit has a blind hole in spatial communication with said base plate opening, said luminous unit further including a light guiding plate disposed on said lower surface of said circuit unit and accommodated in said blind hole and said base plate opening, said luminous element being accommodated in said blind hole and spaced apart from said light guiding plate, said light guiding plate being disposed immediately below said light guiding mask.

8. The luminous press key module of claim 1, further comprising a scissors linkage disposed elevatably between said key cap and said base plate, said key cap being moved vertically together with said scissors linkage toward said base plate when said key cap is pressed.
